(19) United States
(12) Patent Application Publication
(10) Pub. No.: US 2023/0403280 A1
(43) Pub. Date: Dec. 14, 2023

(54) System, Method, and Apparatus for Control of Remote Desktop Connections

(71) Applicant: PC Matic, Inc., Sioux City, IA (US)

(72) Inventor: Andrew G. Tuch, Boca Raton, FL (US)

(73) Assignee: PC Matic, Inc., Sioux City, IA (US)

(21) Appl. No.: 17/838,163

(22) Filed: Jun. 11, 2022

(51) Int. Cl. H04L 9/40

(52) U.S. Cl. CPC H04L 63/101

(57) ABSTRACT

A system for control of remote desktop connections includes security software that interfaces with the operating system of the target device and periodically monitors existing connections (e.g., remote desktop connections) to determine if the connecting device (e.g., the remote computer) is authorized to connect with the target device based upon the name of the connecting device. In some embodiments, as hackers often perform their activities when users are not generally expected to be active, the system for control of remote desktop connections provides a scheduling capability that allows connections only during certain time periods such as 9:00 AM-5:00 PM on Mondays through Fridays.

### FIELD

This invention relates to the field of computing and more particularly to a system for managing remote desktop connections to prevent unauthorized connections.

### BACKGROUND

Operating systems such as Microsoft® Windows® include a connection service that is used for many functions, notably remote management of a device. In such, one using a computer is able to make what is called a remote desktop connection to a target device for remote management of a computer. Once connected, the user of the computer making the connection has access to all files and functionality of the target device.

Security for these remote desktop connections typically requires only a username and password. This is a problem because many usernames and passwords have been disclosed in data breaches or users naturally use weak passwords that can be guessed by hackers who can then connect to the target devices and access any resource on that target device or connected to that target device.

Additionally, some enterprises only want remote access from a safe computer that has proper security installed, for instance a work computer that is supplied by the enterprise. In such, given the prior art, an innocent end user could connect their home computer to a work computer using a remote desktop connection and unknowingly transferring viruses and connections from hackers to the more sensitive work computer, which, having access to enterprise resources, is able to spread the viruses or enable further connections by the hackers.

What is needed is a system that will protect the target device (e.g., a processor-based device) from unauthorized connections, even if the connecting computer has knowledge of the username and password for the target device.

### SUMMARY

Remote desktop connections are very useful, especially in corporate environments or distributed environments in which there is a bonified reason for connecting a computer to a remote device for accessing corporate networks, remote troubleshooting, remote installation by an administrator, remote administration, etc. The system for control of remote desktop connections interfaces with the operating system that is running on the target device and periodically monitors existing remote desktop connections to determine if the connecting device (e.g., the remote computer) is authorized to connect with the target device based upon the name of the connecting device. Further, as hackers often perform their activities when users are not generally expected to be active, the system for control of remote desktop connections provides a scheduling capability that allows certain connections only during certain time periods such as 9:00 AM-5:00 PM on Mondays through Fridays.

In one embodiment, a system for computer security is disclosed including security software running on a target device having connection control data for control of the security software. Upon initialization of the security software, the security software sets a timer and when the timer expires, the security software resets the timer and the security software makes a request for status of all remote computer connections from an operating system. Responsive to the request, the operating system returns a list of all remote computer connections and, for each entry in the list of all remote computer connections, the security software determines if a connecting computer of the entry is authorized to be connected to the target device and when the security software determines that a connecting computer of the entry is unauthorized to be connected to the target device, the security software requests that the operating system of the target device disconnect a connection between the connecting computer of the entry and the target device.

In another embodiment, a method of controlling remote desktop connections to a target device is disclosed including installing security software on the target device. Upon initialization of the security software on the processor, the security software reads connection control data and periodically: obtains a list of connections from an operating system, then for each item in the list of connections, the security software uses the connection control data to determine if a connecting computer name of the item is authorized to be connected to the target device and if the connecting computer name of the item is not authorized to be connected to the target device, the security software instruct the operating system to disconnect a connection between the connecting computer and the target device.

In another embodiment, computer readable instructions providing control of remote desktop connections to a target device are tangibly embodied in a non-transitory storage medium of the target device are disclosed including computer readable instructions running on a processor of the target device. Program instructions tangibly embodied in a non-transitory storage medium of a target device for providing security to the target device, wherein the program instructions comprise computer readable instructions running on a processor of the target device, after the target device is initialized, read connection control data for control of connections to the target device from connecting computers and periodically: obtain a list of connections from an operating system of the target device then for each item in the list of connections, the computer readable instructions running on the processor use the connection control data to determine if a connecting computer name of the item is authorized to be connected to the target device and when the connecting computer name of the item is not authorized to be connected to the target device, the computer readable instructions running on the processor instruct the operating system to disconnect a connection between the connecting computer and the target device.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for control of remote desktop connections.

FIG. 2 illustrates a schematic view of a typical target device controlled by the system for control of remote desktop connections.

FIG. 3 illustrates a schematic view of a typical server computer system.

FIG. 4 illustrates an exemplary program flow of the system for control of remote desktop connections.

FIG. 5 illustrates another exemplary program flow of the system for control of remote desktop connections.

FIG. 6 illustrates an exemplary authorization file of the system for control of remote desktop connections.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “computer” or “target computer” or “target device” refers to any system that has a processor and runs software. One example of such is a personal computer. Another example is a smartphone or tablet. The term, “user” refers to a human that has an interest in the computer, perhaps a user who is using the computer.

In general, the user or an administrator of the system, method, and apparatus being described utilizes the control of remote desktop connections to enhance security of the target device by preventing unauthorized access of the target device as occurs when a hacker attempts to use remote desktop connections to install a virus or steal sensitive data from the target device and/or any corporate resources that are accessible by the target device.

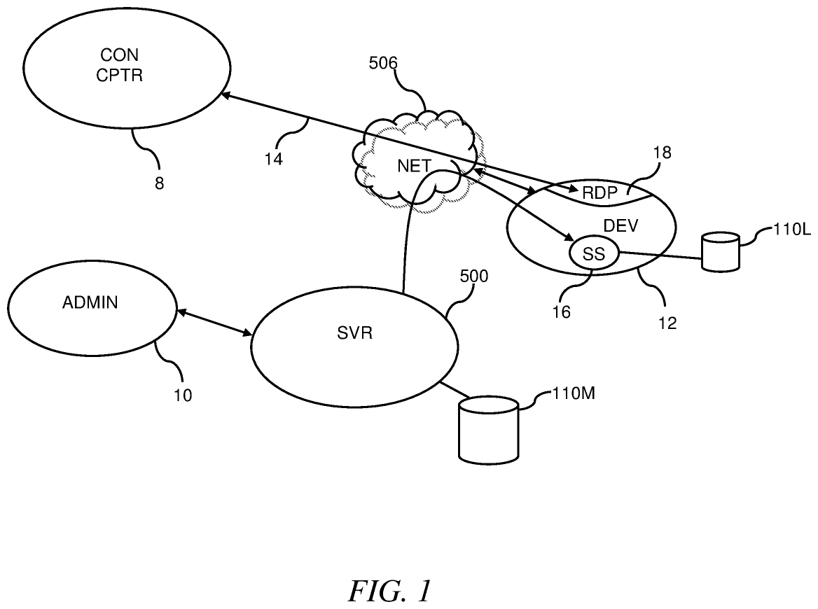

Referring to FIG. 1 illustrates a data connection diagram of the system for control of remote desktop connections. In this example, a master remote authorization file 110M is stored in a storage of a server 500 and manipulated by an administrator device 10, by an administrator. As an example, the master remote authorization file 110M (connection control data) includes computer names of computers that are permitted or excluded to connect to the target device 12, as for example, a whitelist, blacklist, schedule. The administrator edits the master remote authorization file 110M (connection control data) and, once ready, delivers the master remote authorization file 110M to the target device 12 (or many target devices 12) where the remote authorization file is available locally, for example as a local file 110L. In this example, a connecting computer 8 has connected to the target device 12 using a remote desktop connection 14. In some embodiments, the connection control data is transferred to the security software 16 through a connection such as a web socket connection to the server 500.

Once downloaded, the security software 16 accesses the connection control data, and periodically requests the current status of remote desktop connections from the operating system. The operating system returns a list of remote desktop connections. The security software 16 then uses the connection control data to determine if each connection in the list of remote desktop connections is authorized. For example, if the connection control data has a whitelist of computer names, then for each connection that the operating system returned the list of remote desktop connections, if the computer name in the list matches a computer name in the whitelist, then that connection is authorized. Otherwise, if the computer name in the list matches is not present in the whitelist, then the security software 16 makes a request to the operating system to terminate that connection. If the connection control data has a blacklist of computer names or computer name regular expressions, then for each connection that the operating system returned the list of remote desktop connections, if the computer name in absent from the blacklist or does not match a regular expression of the blacklist, then that connection is authorized. Otherwise, if the computer name in present in the blacklist or matches a regular expression of the blacklist, then the security software 16 makes a request to the operating system to terminate that connection. Further, such whitelist/blacklist operations are anticipated to be combinations. Further, in some embodiments, a schedule is included in the connection control data, either for all connections or for individual entries in the whitelist and/or blacklist. For example, a schedule for all connections authorizes connections only between 9:00 AM and 5:00 PM, Monday through Friday, in a specific time zone, independent of the name of the connecting computer. In another example, the connection control data includes a whitelist that always authorizes connections from, for example, the administrative device 10 and only authorizes connections from the connecting computer 8 between 9:00 AM and 5:00 PM, Monday through Friday, in the specific time zone.

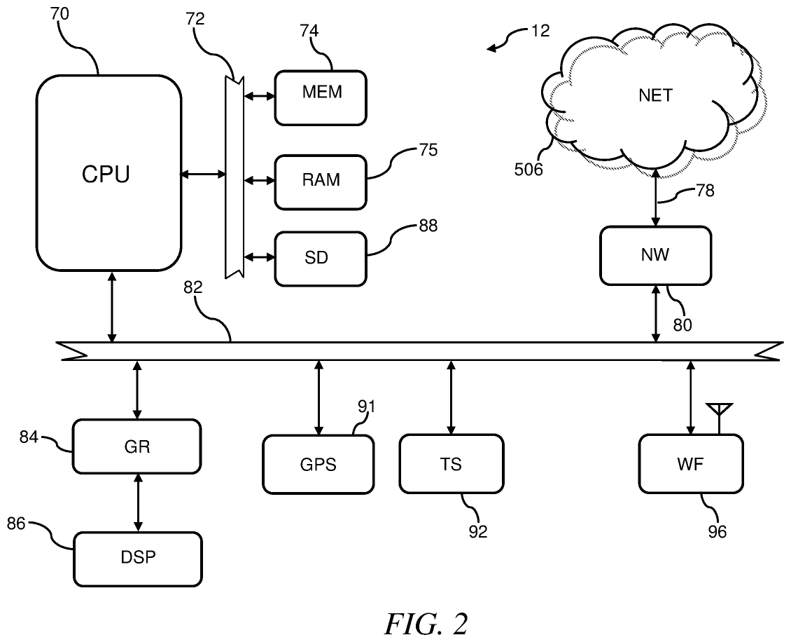

Referring to FIG. 2, a schematic view of an exemplary target device 12 is shown. The exemplary target device 12 is a processor-based device that is protected from malware by security software 16 (see FIG. 1). The present invention is in no way limited to any particular target device 12, as many other processor-based devices are equally anticipated including, but not limited to smart phones, cellular phones, portable digital assistants, routers, thermostats, fitness devices, etc.

The exemplary target device 12 represents a typical device used an end user or employee. This exemplary target device 12 is shown in its simplest form. Different architectures are known that accomplish similar results in a similar fashion, and the present invention is not limited in any way to any particular system architecture or implementation. In this exemplary target device 12, a processor 70 executes or runs programs in a random-access memory 75. The programs are generally stored within a persistent memory 74 and loaded into the random-access memory 75 when needed. In some user devices 12, a removable storage slot 88 (e.g., compact flash, SD) offers removable persistent storage. The processor 70 is any processor, typically a processor designed for phones. The persistent memory 74, random access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary devices 11, the persistent memory 74 is removable, in the form of a memory card of appropriate format such as SD (secure digital) cards, micro-SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceivers 96, touch screen interfaces 92, image sensors, temperature sensors, etc., the details of which are not shown for brevity and clarity reasons.

The network interface 80 connects the exemplary target device 12 to the network 506 (e.g., the Internet) through any known or future protocol such as Ethernet, WI-FI, GSM, TDMA, LTE, etc., through a wired or wireless medium. There is no limitation on the type of connection used. The network interface 80 provides data and messaging connections between the connecting computer 8 and the target device 12.

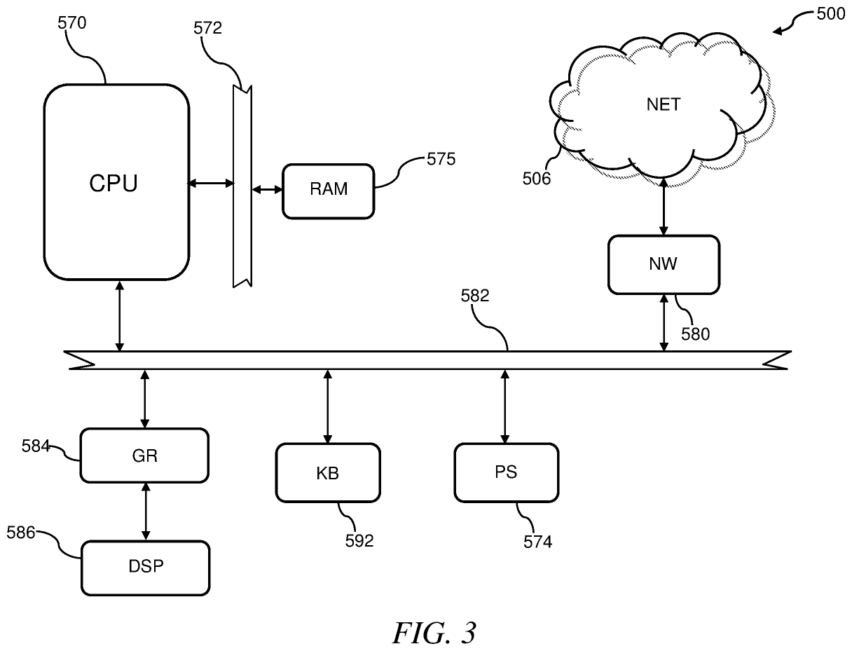

Referring to FIG. 3, a schematic view of a typical server 500 is shown. The exemplary server 500 represents a typical server computer system. Although the exemplary server 500 is shown as a stand-alone system, it is fully anticipated that the server 500 be part of a cloud-computing environment or include multiple computers, one of which is anticipated to be a push server. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a network 506—e.g., the Internet), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, master files 110M, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

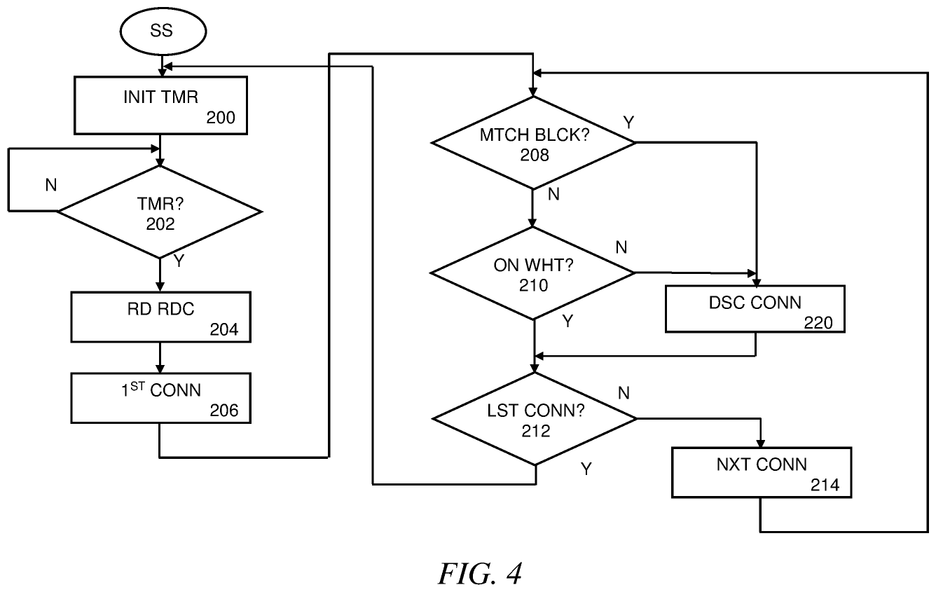

Referring to FIG. 4, an exemplary program flow of the system for control of remote desktop connections is shown. In the example of FIG. 4, the security software 16 has access to a local file 110L which contains connection control data, both a whitelist and a blacklist of connections. The whitelist contains computer names of connecting computers that are to be authorized and the blacklist contains computer names or regular expressions of computer names that are not to be authorized.

There are many ways anticipated to perform the checking for unauthorized connections in a periodic manner (e.g., using timers or interrupts). In this example, the security software 16 sets 200 a timer (for example, 10 seconds) then waits 202 for the time to expire. Once the timer expires, the security software 16 reads 204 the current status of all connections, for example, making a request for status from the operating system which returns a status indicating whether remote connections are currently enabled and a list of existing connections that include an identifier of the connecting computer 8.

The security software 16 then starts with the first connection 206 and checks to see if the identifier of the connecting computer 8 matches a regular expression in the blacklist 208 and if the identifier of the connecting computer 8 matches a regular expression in the blacklist 208 the security software 16 forces the connection to be disconnected 220. Otherwise, if the identifier of the connecting computer 8 does not match any regular expression in the blacklist 208, the security software checks to see if the identifier of the connecting computer 8 matches an entry in the whitelist 210 and if the identifier of the connecting computer 8 does not match an entry in the whitelist 210 the security software 16 forces the connection to be disconnected 220. If the identifier of the connecting computer 8 matches an entry in the whitelist 210 (e.g., is authorized) the security software 16 does not disconnect that connection.

In either case, whether the connection is allowed (authorized) or forced to disconnect (unauthorized), the security software 16 checks 212 to see if this connection is the last connection in the list and if it is the last connection in the list, restarts the next period (e.g., sets the timer 200 again, etc.). If the test 212 indicates that it is not the last connection in the list, the security software 16 moves to the next connection 214 and performs the above tests 208/210 for the next connection.

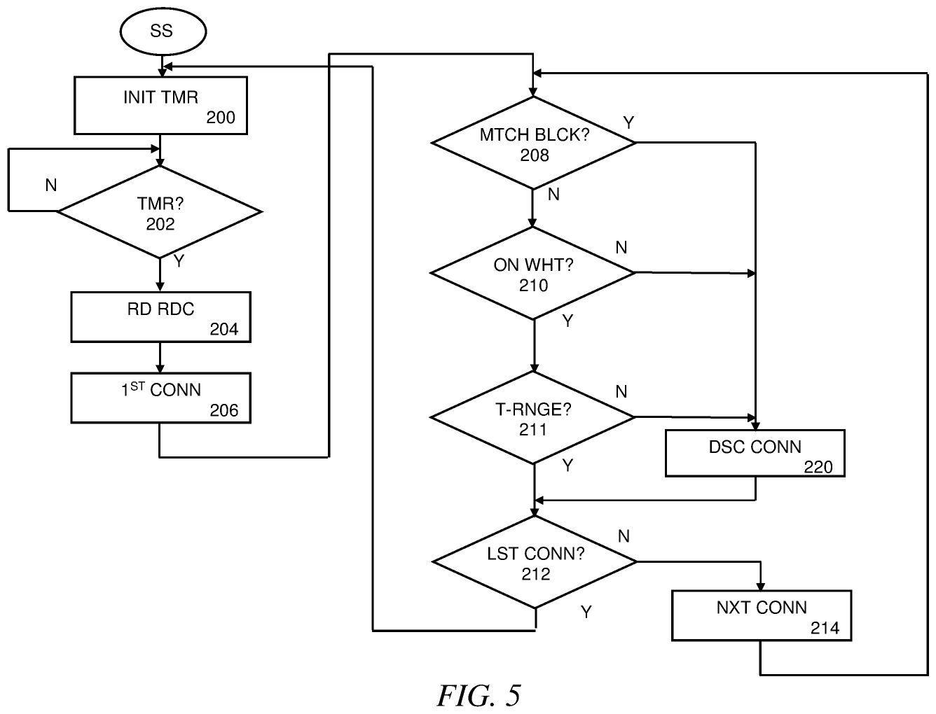

Referring to FIG. 5, an exemplary program flow of the system for control of remote desktop connections is shown. In the example of FIG. 5, the security software 16 has access to the local file 110L which contains both a whitelist and a blacklist of connections. The whitelist contains computer names of connecting computers that are authorized and a time restriction (e.g., a period of time in which the associated entry if authorized or a period of time in which the associated entry is unauthorized) and the blacklist contains computer names or regular expressions of computer names that are not to be authorized.

As with FIG. 4, the security software 16 runs periodically, in this example by setting 200 a timer (for example, 10 seconds) then waiting 202 for the time to expire. Once the timer expires, the security software 16 reads 204 the current status of all connections, for example, making a request for status from the operating system which returns a status indicating whether remote connections are currently enabled and a list of existing connections that include an identifier of the connecting computer 8.

The security software 16 then starts with the first connection 206 and checks to see if the identifier of the connecting computer 8 matches a regular expression in the blacklist 208 and if the identifier of the connecting computer 8 matches a regular expression in the blacklist 208 the security software 16 forces the connection to be disconnected 220. Otherwise, if the identifier of the connecting computer 8 does not match any regular expression in the blacklist 208, the security software checks to see if the identifier of the connecting computer 8 matches an entry in the whitelist 210 and if the identifier of the connecting computer 8 does not match an entry in the whitelist 210 the security software 16 forces the connection to be disconnected 220. If the identifier of the connecting computer 8 matches an entry in the whitelist 210 (e.g., is authorized) the security software 16 checks to see if current time is within a range of time 211 of the authorized entry in the whitelist. For example, the authorized entry in the whitelist is authorized from 9:00 AM to 5:00 PM. In such, if it is 8:00 AM, the current time is not within the range of time 211 of the authorized entry in the whitelist. Therefore, if current time is not within a range of time 211 of the authorized entry in the whitelist, the connection is disconnected 220 and if current time is within the range of time 211 of the authorized entry in the whitelist, the security software 16 does not disconnect that connection.

In either case, whether the connection is allowed (authorized) or forced to disconnect (unauthorized), the security software 16 checks 212 to see if this connection is the last connection in the list and if it is the last connection in the list, restarts (e.g., sets the timer 200 again, etc.). If the test 212 indicates that it is not the last connection in the list, the security software 16 moves to the next connection 214 and performs the above tests 208/210 for the next connection.

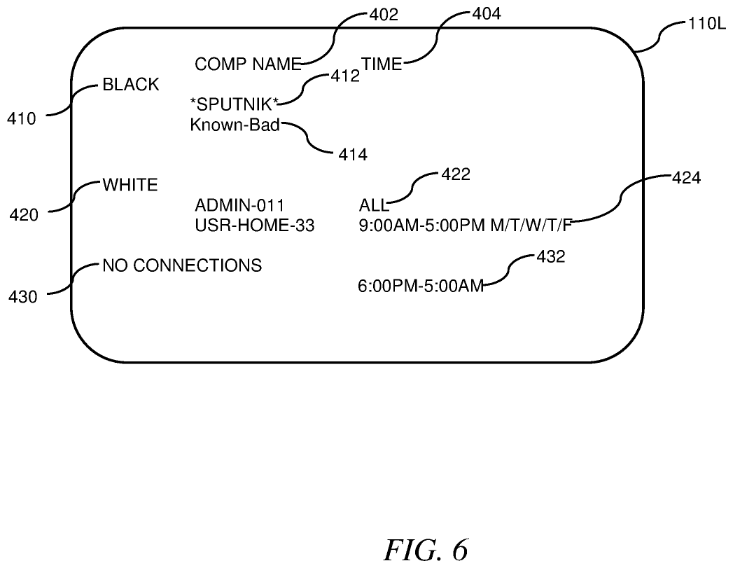

Referring to FIG. 6, an exemplary set of connection control data as, in some embodiments, stored in an authorization file 110L of the system for control of remote desktop connections is shown. In this connection control data, there are blacklist entries 410, whitelist entries 420, and global entries 430.

There are two blacklist entries 410, a first blacklist entries 412 is a regular expression indicating that any connecting computer having the word “SPUTNIK” in the connecting computer's name 402 is unauthorized, as would be used if a certain series of computers are known to be used by hackers. The second blacklist entries 414 is a regular expression indicating that a connecting computer name 402 “Known-Bad” is unauthorized, as would be used if a certain computer is known to be used by hackers.

In this example, there are two whitelist entries 420, a first whitelist entries 422 is for a connecting computer having the computer name 402 of “ADMIN-011,” is always authorized (having “ALL” in the time field 404), as would be used if a certain known computer is used by an administrator. The second whitelist entry 424 is for a connecting computer having the computer name 402 of “USR-HOME-33,” which is authorized from 9:00 AM to 5:00 PM Monday through Friday, as would be used if USR-HOME-33 is known to be a trusted computer, for example, the user's home computer.

Also in this example is a global entry 430 titled “No Connections.” The global entries 430 apply to all connections, whether in the above lists or not. In this example, there is a timer global entry 432 that indicates no connections are allowed between the time of 6:00 PM and on all days. Therefore, even if a connecting computer 8 having a computer name 402 that is in the whitelist 420, for example, “ADMIN-011,” any connection from any connecting computer 8 is automatically disconnected by the security software 16.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security, the system comprising:
security software running on a target device, the security software having connection control data;
upon initialization of the security software, the security software sets a timer; and
when the timer expires, the security software resets the timer and the security software makes a request for status of all remote computer connections from an operating system, responsive to the request, the operating system returns a list of all remote computer connections and, for each entry in the list of all remote computer connections, the security software uses the connection control data to determine if a connecting computer of the entry is authorized to be connected to the target device and when the security software determines that a connecting computer of the entry is unauthorized to be connected to the target device, the security software requests that the operating system of the target device disconnect a connection between the connecting computer of the entry and the target device.

2. The system of claim 1, wherein the security software determines if the connecting computer of the entry is authorized by an absence of a name of the connecting computer from a blacklist of the connection control data.

3. The system of claim 1, wherein the security software determines if the connecting computer of the entry is authorized by a presence of a name of the connecting computer on a whitelist of the connection control data.

4. The system of claim 1, wherein the security software determines if the connecting computer of the entry is authorized by an absence of a name of the connecting computer from a blacklist of the connection control data and a presence of the name of the connecting computer on a whitelist of the connection control data.

5. The system of claim 1, wherein the security software determines if the connecting computer of the entry is authorized by an absence of a name of the connecting computer from a blacklist of the connection control data and a presence of the name of the connecting computer on a whitelist of the connection control data and a local time being within a range of times associated with the connecting computer in the whitelist.

6. The system of claim 1, wherein the connection control data includes a global timeframe and when a local time is within the global timeframe, the security software requests that the operating system of the target device disconnect any connection to any connecting computer.

7. The system of claim 1, wherein the remote computer connections are remoted desktop connections.

8. A method of protecting a target device, the target device having a processor, the method comprising:
installing security software on the target device, the security software running on the processor;
upon initialization of the security software on the processor, loading connection control data by the security software; and
periodically:
the security software obtaining a list of connections from an operating system that is running on the target device; and
for each item in the list of connections, the security software using the connection control data to determine if a computer name of the item is authorized to be connected to the target device and when the computer name of the item is not authorized to be connected to the target device, the security software instructing the operating system to disconnect a connection between the computer having that computer name and the target device.

9. The method of claim 8, wherein the step of the security software determining if the computer name of the item is authorized to be connected to the target device includes finding an absence of the computer name of the item from a blacklist of the connection control data.

10. The method of claim 8, wherein the step of the security software determining if the computer name of the item is authorized to be connected to the target device includes finding the computer name of the item on a whitelist of the connection control data.

11. The method of claim 8, wherein the step of the security software determining if the computer name of the item is authorized to be connected to the target device includes finding an absence of the computer name of the item from a blacklist of the connection control data and finding the computer name of the item on a whitelist of the connection control data.

12. The method of claim 8, wherein the step of the security software determining if the computer name of the item is authorized to be connected to the target device includes finding an absence of the computer name of the item from a blacklist of the connection control data and finding the computer name of the item on a whitelist of the connection control data and a local time being within a range of times associated with item in the whitelist.

13. The method of claim 8, wherein the step of the security software determining if the computer name of the item is authorized to be connected to the target device includes determining when a local time is within a range of times associated with a global item in the connection control data and when the local time is within the range of times associated with a global item in the connection control data, the security software requests that the operating system of the target device disconnect any connection to any connecting computer.

14. The method of claim 8, wherein each item in the list of connections designates a connection to the target device using a remoted desktop connection.

15. Program instructions tangibly embodied in a non-transitory storage medium of a target device for providing security to the target device, wherein the program instructions comprise:
after the target device is initialized, computer readable instructions running on a processor of the target device reads connection control data; and
periodically:
the computer readable instructions running on the processor obtain a list of connections from an operating system that is running on the target device; and
for each item in the list of connections, the computer readable instructions running on the processor determines if a computer name of the item is authorized to be connected to the target device using the connection control data and if the computer name of the item is not authorized to be connected to the target device, the computer readable instructions running on the processor instruct the operating system to disconnect a connection between the computer name and the target device.

16. The program instructions tangibly embodied in the non-transitory storage medium of claim 15, wherein the computer readable instructions running on the processor determine if the computer name of the item is authorized to be connected to the target device by finding an absence of the computer name of the item from a blacklist of the connection control data or finding the computer name of the item on a whitelist of the connection control data.

17. The program instructions tangibly embodied in the non-transitory storage medium of claim 15, wherein the computer readable instructions running on the processor determines if the computer name of the item is authorized to be connected to the target device by finding an absence of the computer name of the item from a blacklist of the connection control data or finding the computer name of the item on a whitelist of the connection control data and a local time being within a range of times associated with the item in the whitelist.

18. The program instructions tangibly embodied in the non-transitory storage medium of claim 15, wherein the computer readable instructions running on the processor determines if a local time is within a range of times associated with a global item in the connection control data and when the local time is within the range of times associated with a global item in the connection control data, the computer readable instructions running on the processor requests that the operating system of the target device disconnect any connection to any connecting computer.

19. The program instructions tangibly embodied in the non-transitory storage medium of claim 15, wherein the connections to the target device are made using remoted desktop connections.
